(19) United States
(12) Patent Application Publication
(10) Pub. No.: US 2012/0166403 A1
(43) Pub. Date: Jun. 28, 2012

(54) DISTRIBUTED STORAGE SYSTEM HAVING CONTENT-BASED DEDUPLICATION FUNCTION AND OBJECT STORING METHOD

(76) Inventors: Mi-Jeom KIM, Gyeonggi-do (KR); Hyo-Min Kim, Seoul (KR); Eo-Hyung Lee, Gyeonggi-do (KR); Jin-Kyung Hwang, Gyeonggi-do (KR)

(21) Appl. No.: 13/336,114

(22) Filed: Dec. 23, 2011

(30) Foreign Application Priority Data
Dec. 24, 2010 (KR) 10-2010-0134842

(51) Int. Cl. G06F 17/30

(52) U.S. Cl. 707/692; 707/E17.005

(57) ABSTRACT

Distributed storage system having content-based deduplication function and object storing method. The distributed storage system may include a plurality of data nodes and a server coupled with the plurality of data nodes. Each one of the plurality of data nodes may be configured to store at least one object. The server may be configured to perform a deduplication function based on a content-specific index of a target object and content-specific indexes of objects stored in the plurality of data nodes in response to an object storage request from a client, and configured to store the target object in one of the plurality of data nodes based on a result of the deduplication function performed by the server.

### CROSS REFERENCE TO PRIOR APPLICATIONS

The present application claims priority under 35 U.S.C. §119 to Korean Patent Application No. 10-2010-0134842 (filed on Dec. 24, 2010), which is hereby incorporated by reference in its entirety.

### FIELD OF THE INVENTION

Apparatuses and methods consistent with the present invention relate to a content-based object storage technology for effectively performing object deduplication in a distributed storage system.

More particularly, apparatuses and methods consistent with the present invention relate to a distributed storage system for effectively storing objects in a plurality of data nodes distributed over a network, without unnecessary duplications.

### BACKGROUND OF THE INVENTION

Cloud computing may be referred to as a service that provides various information technology (IT) resources distributed over an Internet. The most common cloud computing service models may include Infrastructure as a Service (IaaS), Platform as a Service (PaaS), and Software as a Service (SaaS). The IaaS may provide hardware infrastructure as a service. The PaaS may provide application development and execution platform as a service. The SaaS may provide applications as a service.

The IaaS may further include many sub_service categories. Mainly, the IaaS may include a storage service and a computing service, which provide computing resources in a form of a virtual machine. Such a storage service may be provided by a distributed storage system. The distributed storage system may virtually create a storage pool using low-profiled hardware distributed over a network. Such a distributed storage system may dynamically and flexibly provide a shared storage space to users according to abruptly varying service demands. The distributed storage system may commonly employ an object-based storage scheme. The object-based storage scheme may be a typical cloud storage service scheme. The object-based storage scheme may allow each physical storage device to manage its own storage spaces. The object-based storage scheme may improve overall performance of the distributed storage system and allow the distributed storage system to easily expand a storage capability. Furthermore, data may be safely shared independently from related platforms.

The typical distributed storage system may include a plurality of object-based storages. The typical distributed storage system may replicate data and store replicated data in at least one object-based storage for data safety and high data availability. The replicated data may be referred to as a replica. The distributed storage system may generally have two or three replicas, but may have more than three replicas, depending on an importance of a respective object. The distributed storage system may be required to synchronize the replicas of a respective object. Such synchronization may be processed by an independent replication server (not shown).

As an opposite concept to data replication, a data deduplication technology has been introduced. The data deduplication technology may control storages distributed over a network to store only one object even when there is a request for redundantly storing a plurality of objects having the same contents. For example, due to requests from many users, the same movie files may be redundantly stored in a plurality of storages distributed over a network. That is, a plurality of a same object may be stored in storages distributed over a network. Although there are requests for storing the same objects redundantly, the data deduplication technology may store one object in a certain storage and maintain a corresponding metadata including information on a location of the respective object. In this case, few replicas thereof may be stored in other storages. When there is a later request to store or update the same object even from other clients, related metadata is provided instead of storing the same object in different storages. After providing the related metadata, the related metadata may be updated and maintained. The data deduplication technology may expand overall storage capability in a distributed storage system and reduce costs for maintaining the distributed storage system by not storing duplicates of the same object.

A typical data deduplication technology may refer to a name of a respective object in order to remove duplicated objects or to prevent objects from being duplicated. That is, all data nodes may be scanned to detect the same logical object name. Such a method may be referred to as a physical location mapping method. The physical location mapping method may generate a great processing load and cause a processing latency because it may be required to scan and analyze all objects in every storage node in order to find duplicates.

Therefore, there is a need for developing a method of effectively distributing and storing objects while supporting a data deduplication technology. In addition, there is a need for a metadata structure that supports a data deduplication technology.

### SUMMARY OF THE INVENTION

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present invention, a content-based object storing method may be provided for eliminating redundancy in a distributed storage system for a cloud storage service.

In accordance with another aspect of the present invention, a metadata structure may be provided for efficiently performing an object deduplication operation.

In accordance with an embodiment of the present invention, a distributed storage system may include a plurality of data nodes and a server coupled with the plurality of data nodes. Each one of the plurality of data nodes may be configured to store at least one object. The server may be configured to perform a deduplication function based on a content-specific index of a target object and content-specific indexes of objects stored in the plurality of data nodes in response to an object storage request from a client, and configured to store the target object in one of the plurality of data nodes based on a result of the deduplication function performed by the server.

The server may calculate the content-specific indexes of the target object and the objects by applying a hash function on a portion of a content of each respective object.

The hash function may be one of MD5, SHA1, SHA256, SHA384, SHA512, RMD128, RMD160, RMD256, RMD320, HAS160 and TIGER. The hash function may receive the portion of the content of each respective object as an input and outputs a fixed length hash result as the content-specific index of the respective object.

In accordance with another embodiment of the present invention, a distributed storage system may include an authentication server, a plurality of data nodes, a metadata database, and a proxy server. The authentication server may be configured to authenticate a plurality of clients accessing the distributed storage system. Each one of the plurality of data nodes may be configured to store at least one object. The metadata database may be configured to store metadata containing information on the at least one object of each of the plurality of data nodes and information on the plurality of data nodes each storing the at least one object. The proxy server may be configured to receive an object storage request from a first client of the plurality of clients to store a target object, determine a content-specific index based on contents of the target object, perform a deduplication function based on the determined content-specific index of the target object, select target data nodes from the plurality of data nodes based on a result of the performed deduplication function, and provide a list of the selected target data nodes to the first client. The first client may store the target object in at least one target node included in the list of the selected target data nodes.

The proxy server may be configured to apply a hash function to a portion of the contents of the target object and determine a hash result of the applied hash function as the content-specific index of the target object.

The metadata may include an object table and a replica location table. The object table may include at least one of a user ID, a directory ID, an object ID, and the content-specific index, and the replica location table may include the content-specific index and at least one data node ID of a data node storing replicas of a respective object.

The metadata may further include at least one of an available capacity of each data node of the plurality of data nodes, a list of data nodes belonging to each zone group, a priority of each zone group with respect to the target object, and a priority of each data node belonging to a first zone group.

The plurality of data nodes may be grouped into at least one zone group, and the proxy server may be configured to select one target node from each zone group in order to store the target object into only one data node within each zone group.

The distributed storage system may further include a location-aware server. The location-aware server may be configured to select a plurality of zone groups within which to store the target object based on a location of the first client and determine priorities of the selected zone groups based on a distance between the first client and respective zone groups. The proxy server may select one target data node per selected zone group, update the metadata database using a list of the selected target data nodes, and transmit the list of the selected target data nodes and the priorities of the selected zone groups to the first client. The first client may select one target data node belonging to a zone group having a highest priority from among the selected zone groups, store the target object within the selected one target data node, select at least one target data nods belonging to zone groups having priorities lower than the highest priority, and store replicas of the target object within the selected at least one target data node.

The proxy server may assign a priority to each data node belonging to one zone group based on an object storage history and a storage capacity of each data node, and determine a data node having the highest priority as the target data node.

The information on the at least one object may include at least one of an ID, a size, a data type, and a creator of the at least one object. The information on the plurality of data nodes may include at least one of an ID, an Internet protocol (IP) address, and a physical location of the plurality of data nodes.

In accordance with another embodiment of the present invention, a method may be provided for storing objects in a distributed storage system having a plurality of data nodes. The method may include receiving an object storage request from a client intending to store a target object, determining a content-specific index based on contents of the target object, performing a deduplication function to determine whether or not the target object is duplicative of objects already stored within at least one of the plurality of data nodes based on the determined content-specific index, and selecting at least one target data node from the plurality of data nodes within which to store the target object based on a result of the deduplication function, metadata including information on objects stored within the plurality of data nodes, and information on the plurality of data nodes storing the objects.

The determining the content-specific index may include applying a hash function on a portion of a content of the target object, wherein a hash result of the applied hash function is determined as the content-specific index of the target object.

The selecting the at least one target data node may include selecting a plurality of zone groups within which to store the target object based on a location of the client and determining priorities of the selected zone groups based on a distance between the client and respective zone groups. One target data node may be selected per selected zone group. The metadata database may be updated using a list of the selected target data nodes. The list of the selected target data nodes and the priorities of the selected zone groups may be transmitted to the client. Then, the client may select one target data node belonging to a zone group having a highest priority from among the selected zone groups, store the target object within the selected one target data node, select at least one target data node belonging to zone groups having priorities lower than the highest priority, and store replicas of the target object within the selected at least one target data node.

A priority may be assigned to each data node belonging to one zone group based on an object storage history and a storage capacity of each data node and a data node having the highest priority may be selected as the target data node within the one zone group.

The metadata may further include at least one of an available capacity of each data node of the plurality of data nodes, a list of data nodes belonging to each zone group, a priority of each zone group with respect to the target object, and a priority of each data node belonging to the one zone group.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates a related art distributed storage system;

FIG. 2 illustrates a distributed storage system supporting a deduplication function, in accordance with an embodiment of the present invention;

FIG. 3 illustrates an object storing method of a distributed storage system having a deduplication function, in accordance with an embodiment of the present invention;

FIG. 4 illustrates a table showing various hash functions applicable to a distributed storage system in accordance with an embodiment of the present invention;

FIGS. 5A and 5B illustrate tables included in metadata, in accordance with an embodiment of the present invention; and

FIG. 6 illustrates a distributed storage system having a deduplication function, in accordance with another embodiment of the present invention.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

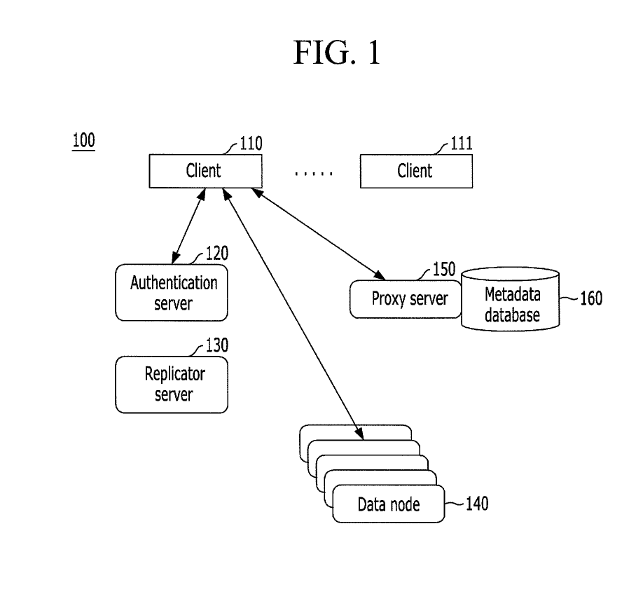

FIG. 1 illustrates a distributed storage system.

Referring to FIG. 1, a distributed storage system 100 may include a plurality of clients 110 and 111, an authentication server 120, a replicator server 130, a plurality of data nodes 140, a proxy server 150, and a metadata database 160.

The authentication server 120 may authenticate the plurality of clients 110 and 111 accessing the distributed storage system 100. The proxy server 150 may be referred to as a master server. The proxy server 150 may process various requests from the clients 110 and 111. The metadata database 160 may store and maintain metadata. The metadata may include information on physical locations of objects. The plurality of data nodes 140 may store and manage actual objects. The replicator server 130 may manage object replication.

At an initial stage, the clients 110 and 111 are authenticated through the authentication server 120. After the authentication process is completed, the clients 110 and 111 may request the proxy server 150 to send information on the data nodes 140 that store and manage desired objects. The proxy server 150 may request a respective data node 140 to perform a desired operation based on the metadata in response to a request from the clients 110 and 111. The respective data node 140 may perform the requested operation and transmit the operation result to the clients 110 and 111 through the proxy server 150. In addition, the respective data node 140 may directly provide the operation result to the clients 110 and 111, without passing through the proxy server 150. Since the plurality of data nodes 140 directly communicate with the clients 110 and 111, delay or data traffic may be reduced. However, the complexity of the plurality of data nodes 140 may be increased because all data nodes are required to have client interfaces. Furthermore, the same objects may be redundantly stored in two or more data nodes.

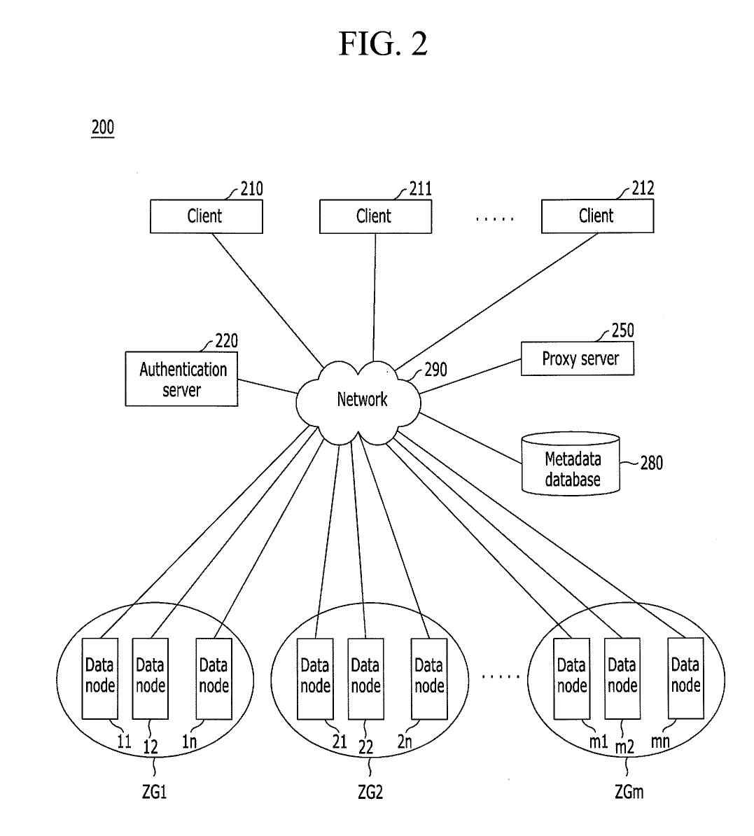

FIG. 2 illustrates a distributed storage system supporting a deduplication function, in accordance with an embodiment of the present invention.

Referring to FIG. 2, the distributed storage system 200 may include a plurality of clients 210 to 212 and a plurality of data nodes 11 to 1n, 21 to 2n, and m1 to mn. The plurality of clients 210 to 212 and the plurality of data nodes 11 to mn may be coupled through a network 290. The distributed storage system 200 may further include an authentication server 220, a proxy server 250, and a metadata database 280.

The authentication server 220 may authenticate the clients 210 to 212. Each one of the data nodes 11 to 1n, 21 to 2n, and m1 to mn may store at least one object. The metadata database 280 may store metadata containing information on the objects and information on the data nodes 11 to 1n, 21 to 2n, and m1 to mn.

For convenience and ease of understanding, operations of the distributed storage system 200 will be described when a first client 210 attempts to store an object in one of the data nodes 11 to 1n, 21 to 2n, and m1 to mn. The present invention, however, is not limited thereto.

When the first client 210 desires to store a target object, the first client 210 may transmit an object storage request to the proxy server 250. Although the proxy server 250 receives the object storage request from the first client 210, the proxy server 250 may not immediately store the target object at a desired data node. Instead, the proxy server 250 may perform a deduplication operation. For example, the proxy server 250 may determine whether or not the target object has been already stored in one of the data nodes 11 to 1n, 21 to 2n, and m1 to mn.

In order to perform such a deduplication operation, the proxy server 250 may determine a content-specific index based on contents of the target object. The proxy server 250 may use the determined content-specific index to determine whether or not the target object has been stored in one of the data nodes 11 to 1n, 21 to 2n, and m1 to mn. When the proxy server 250 determines that the target object has been stored in one of the data nodes 11 to 1n, 21 to 2n, and m1 to mn, the proxy server 250 may ignore the object storage request. Therefore, such an operation may prevent system resources from being wasted because the same objects are not unnecessarily and redundantly stored in more than one of data nodes 11 to 1n, 21 to 2n, and m1 to mn.

When the proxy server 250 determines that the target object has not been stored in any of the data nodes 11 to 1n, 21 to 2n, and m1 to mn, the proxy server 250 may provide the first client 210 with a list of target data nodes in which to store the target object. The list may include unique information on the target data nodes. As described above, the target data node list may be provided for unduplicated objects. The first client 210 may identify and select one target data node from the provided target data node list. The first client 210 may store the target object in the selected target data node using an IP address of the selected target data node.

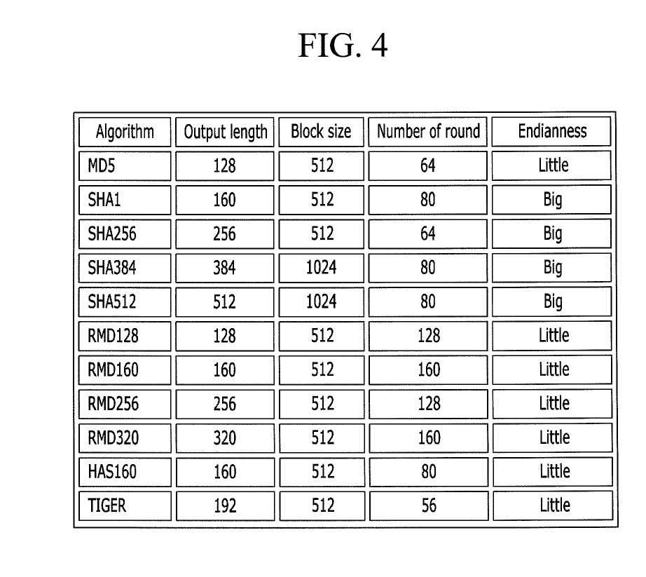

In order to determine a content-specific index, a hash function may be used in accordance with an embodiment of the present invention. For example, the proxy server 250 may apply a hash function to a predetermined portion of a target object. Particularly, the hash function may be applied to a first 65 megabytes of the target object. The proxy server 250 may determine the hash function result as a content-specific index of the corresponding target object. The content-specific index may be information to be used for finding duplicated target objects. The hash function used by the proxy server 250 will be described below, in detail, with reference to FIG. 4.

As described above, the proxy server 250 may use the content-specific index to determine whether or not any data node stores objects identical to the target object. Therefore, even though another client may have already stored an object identical to the target object but having a different name, the proxy server 250 may easily determine that a respective object is identical to the target object.

The target object may denote an object that a client desires to store or that a client wants to search for from data nodes. The target data node may denote a data node storing the target object among a plurality of data nodes. Priorities may be assigned to each data node and/or each zone group. Such priorities may denote a ranking of each data node and/or each zone group. The priorities may indicate a suitability level of a data node or a zone group for storing a target object, as compared to other data nodes or other zone groups.

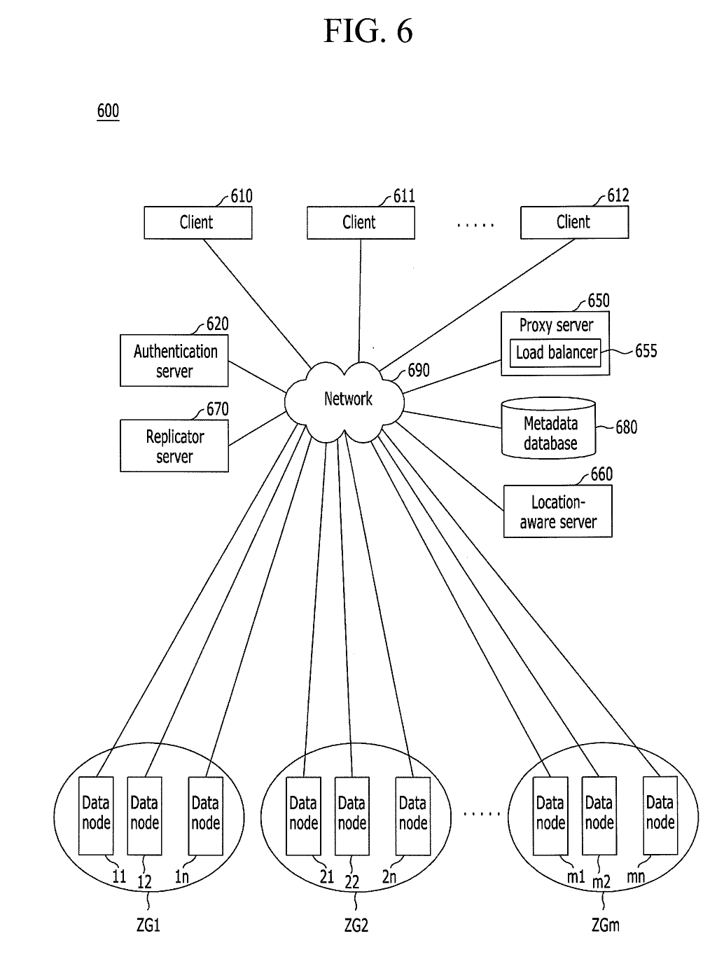

The priorities may include a zone group priority and a data node priority. The zone group priority may denote a suitability level of a zone group for storing a target object, as compared to other zone groups. The data node priority may denote a suitability level of a data node for storing a target object, as compared to other data nodes. Such priorities may be determined based on a client preference of a data node zone or a client preference of a data node. Furthermore, the priorities may be determined automatically by the proxy server 250 or a location-aware server 620 of FIG. 6. The priorities will be described in more detail later.

The data nodes 11 to 1n, 21 to 2n, and m1 to mn may be grouped by zone. The distributed storage system 200 may group the plurality of data nodes 11 to 1n, 21 to 2n, and ml to mn based on locations thereof. As shown in FIG. 2, the distributed storage system 200 may group the plurality of data nodes 11 to 1n, 21 to 2n, and m1 to mn into the three zone groups of ZG1, ZG2 and ZGm. Each zone group may include data nodes located in a specific zone. Particularly, the data nodes 11 to 1n may be included in a first zone group ZG1, the data nodes 21 to 2n may be included in a second zone group ZG2, and the data nodes ml to mn may be included in an m^{th} zone group ZGm, as shown in FIG. 2. Since the plurality of data nodes 11 to 1n, 21 to 2n, and m1 to mn are grouped based on locations thereof, the distributed storage system 200 may effectively store an object and replicas thereof in data nodes distributed over a network.

The distributed storage system 200 may not store an object and replicas thereof in data nodes belonging to the same zone group. Particularly, the distributed storage system 200 may not store identical objects in more than one data node belonging to the same zone group. For example, the distributed storage system 200 may store an object in a data node of a first zone group and store any replicas of the object in data nodes in zone groups different from the first zone group. Furthermore, the distributed storage system 200 may not store replicas of the same object in data nodes belonging to the same zone group. Accordingly, each one of the replicas of an object may be stored in one or more data nodes of different zone groups.

Metadata may include information on physical locations of an object and replicas thereof. Particularly, the metadata may include information on mapping relation of objects including replicas thereof and corresponding data nodes that store the objects.

The above described manner of storing an object and replicas thereof may increase data reliability because replicas of one object are distributively stored in data nodes in different zone groups. For example, when a replica in one zone group is damaged due to errors of a respective network, a user can retrieve another replica stored in a data node in a different zone group.

In accordance with an embodiment of the present invention, a zone group may be a single data center or a single server rack, but the present invention is not limited thereto. After a zone group is defined and a plurality of data nodes are grouped by each zone group, mapping relation between a data node and a corresponding zone group may be updated in the metadata. After updating the metadata, replicas of one object may be replicated in respective data nodes in different zone groups.

Grouping the data nodes into the zone groups may have the following advantages. In accordance with an embodiment of the present invention, the clients 210, 211 and 212 and the data nodes 11 to 1n, 21 to 2n, and m1 to mn may communicate with each other over the network 290. That is, virtual channels may be established between the clients 210, 211 and 212 and the respective data nodes 11 to 1n, 21 to 2n, and m1 to mn.

However, the virtual channels do not always have the same conditions with respect to pairs of one of the clients 210, 211 and 212 and one of the data nodes 11 to 1n, 21 to 2n, and m1 to mn. For example, conditions of such a virtual channel may be dynamically changed according to various factors such as physical distances between a client and a corresponding data node. For example, as the physical distance between a client and a corresponding data node increases, it may take a longer time to transmit/receive a target object because the target object may be relayed through more nodes or gateways.

In addition, the conditions of the virtual channel may be changed according to an amount of network traffic and/or performance of network resources configuring a respective virtual channel. As the amount of the network traffic over a respective virtual channel is comparatively great, it is highly likely that transmission collision will occur on the respective virtual channel. As the performance of the network resources is comparatively higher, the transmission/reception speed of the virtual channels may become faster.

In accordance with an embodiment of the present invention, a virtual channel between one of the clients 210, 211 and 212 and a respective one of the data nodes 11 to 1n, 21 to 2n, and m1 to mn may be selected based on the above described conditions. In order to select the most optimal virtual channel, the distributed storage system 200 may refer to the physical distance between the clients 210, 211 and 212 and the zone groups ZG1, ZG2 and ZGm. Therefore, an object upload time may be minimized by storing the object in the data node belonging to the zone group located at the shortest distance from the respective client having an object to be stored.

In accordance with an embodiment of the present invention, the distributed storage system 200 does not store replicas of the same object in data nodes belonging to the same zone group. In this manner, replicas of the target object may be distributively stored over a plurality of zone groups. Accordingly, data availability and data reliability may be improved. For example, a data center may be defined as one zone group including a plurality of data nodes. Such a data center can malfunction due to power failure. In this case, a user cannot access all data nodes belonging to the data center. Since the distributed storage system stores replicas distributively over a plurality of zone groups, for example, different data centers, a user may access a desired data stored in a different data center.

As described above, the distributed storage system 200 in accordance with an embodiment of the present invention may create metadata with a content-specific index instead of a physical name of the object. Accordingly, the distributed storage system 200 performs the deduplication operation more efficiently and accurately even though same objects may have different names.

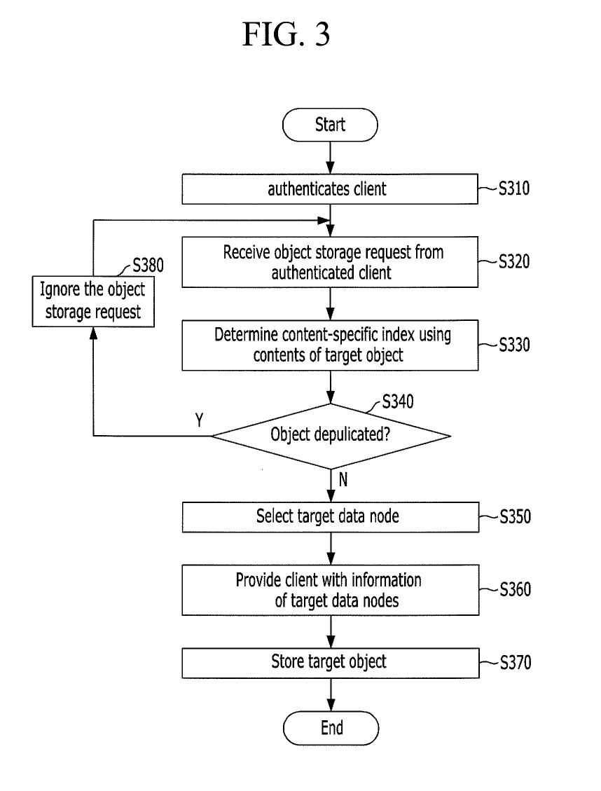

FIG. 3 illustrates an object storing method of a distributed storage system having a deduplication function, in accordance with an embodiment of the present invention.

Referring to FIG. 3, an authentication procedure may be performed S310. For example, when clients initially access a distributed storage system 200, an authentication server 220 may authenticate clients.

After the authentication procedure, an object storage request may be transmitted S320. For example, when a respective client wants to store a target object after being successfully authenticated, the respective client may transmit an object storage request to a proxy server 250.

A content-specific index of the target object may be determined based on the contents of the target object S330. For example, in response to the object storage request, the proxy server 250 may determine a content-specific index of the target object based on the contents thereof.

A determination may be made as to whether or not the target object has already been stored in one of the data nodes S340. For example, when the content-specific index is determined based on the contents of the target object, the proxy server 250 may determine whether the target object is duplicated with objects stored in one of the data nodes 11 to mn based on the determined content-specific index.

When it is determined that the target object is not duplicated (S340-No), at least one of the data nodes 11 to mn may be selected as a target data node S350. For example, the proxy server 250 may select at least one of the data nodes 11 to mn as a target data node to store the target object. In order to select the target data node, the proxy server 250 may refer to a priority of each data node. Such priority may be predetermined in consideration of a storage capacity of each data node for load balancing. For example, the proxy server 250 may select a data node having the highest priority as the target data node. In this manner, the loads of the data nodes may be effectively balanced.

After selecting the target data node, information on the selected target data node may be provided to the client S360. For example, the proxy server 250 may provide a client with unique information on the selected target data node. The unique information may be a list of the selected target data nodes.

The target object may be stored in the target data node S370. For example, the client may store the target object in the target data node based on the information received from the proxy server 250.

On the contrary, when it is determined that the target object is duplicated with an object already stored in at least one of the data nodes 11 to mn (S340-Yes), the corresponding object storage request may be ignored S380. For example, the proxy server 250 may ignore the corresponding object storage request. Then, the proxy server 250 may wait for another request.

As described above, the proxy server 250 may use a content-specific index to determine whether or not the target object has been stored in at least one of the data nodes 11 to mn. In accordance with an embodiment of the present invention, the content-specific index may be generated using a hash function. That is, the proxy server 250 may compare a hash value of the target object with that of a respective object already stored in at least one of the data nodes. Therefore, the distributed storage system 200 may effectively perform the deduplication operation. For example, the proxy server 250 may apply a hash function to the target object to obtain a hash value as the content-specific index. The proxy server 250 may determine whether or not any objects stored in the data nodes 11 to mn have the same hash value of the target object. When an object stored in the data nodes 11 to mn has the same hash value, the proxy server 250 determines the target object has been duplicated in one of the data nodes 11 to mn. Since the hash function will almost never generate the same hash value for different objects, the proxy server 250 may effectively determine whether or not the target object has been duplicated.

FIG. 4 illustrates a table showing various hash functions applicable to a distributed storage system in accordance with an embodiment of the present invention.

In general, a hash function may compress an input message having an arbitrary length into an output value having a fixed length. Such a hash function has been widely used for data integrity check and message authentication. In order to apply a hash function, the hash function may be required to meet two conditions: one-wayness and strong collision resistance. When the hash function is used, it may be computationally impossible to find an arbitrary input message meeting the given conditions.

In order to generate a content-specific index of an object, the proxy server 250 may use one of the hash functions shown in FIG. 4. The table of FIG. 4 shows properties of each hash function, such as an output length, a block size, a number of rounds, and endianness. The endianness may refer to a method of arranging a plurality of successive objects in one-dimensional space such as in a computer memory.

As shown in FIG. 4, various hash functions including MD5, SHA1, SHA256, SHA384, SHA512, RMD128, RMD160, RMD256, RMD320, HAS160, and TIGER may be applicable to the distributed storage system 200 in accordance with an embodiment of the present invention, but the present invention is not limited thereto.

The hash function MD5 has been widely used. The hash function MD5 may have a problem in collision resistance. The hash function SHA1 may be designed for data structure analysis (DSA). The hash function SHA1 has been used as a default hash function in many Internet applications.

Furthermore, the hash functions SHA256, SHA384 and SHA512 may have output lengths extended in correspondence to key lengths of advanced encryption standards such as 128-bit, 192-bit, and 256-bit. The hash functions RMD128 and RMD160 may be designed to substitute for the hash function MD4 or MD5 and a hash function RIPEMD of a project RACE Integrity Primitives Evaluation (RIPE). The hash function RMD128 may also have a problem in collision resistance. The hash function RMD160 may have low efficiency but high stability. The hash function RMD160 is widely adopted in many Internet standards. The hash functions RMD256 and RMD320 may be extensions of RMD128 and RMD160, respectively.

The hash function HAS160 has been developed as a Korean certificate-based digital signature algorithm (KCDSA). The hash function HAS160 may have similar advantages to the hash functions MD5 and SHA1. The hash function TIGER may be optimized for a 64-bit processor so the hash function TIGER may provide a hash value very quickly in the 64-bit processor.

In accordance with an embodiment of the present invention, the proxy server 250 may apply various hash functions to objects in order to obtain a hash value and uses the hash value as a content-specific index.

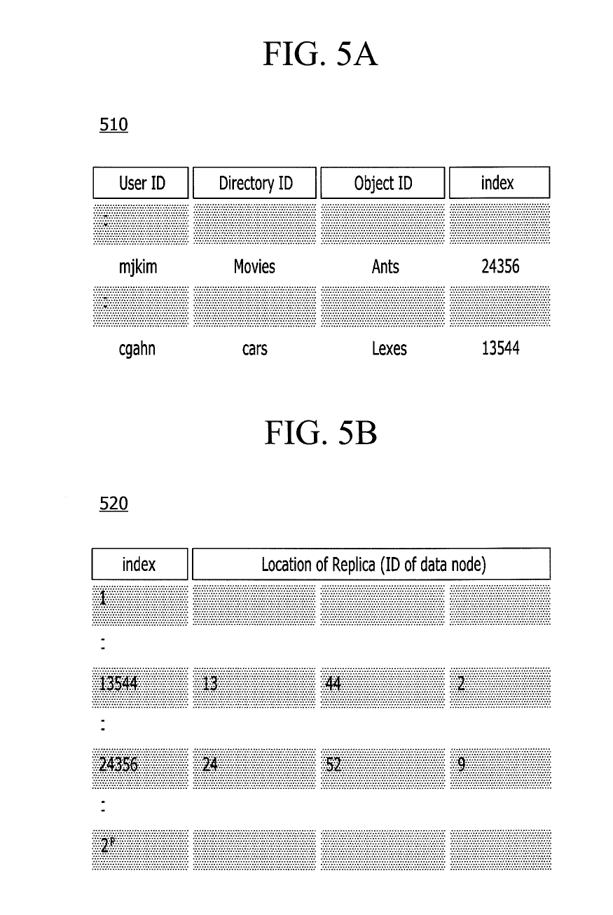

FIGS. 5A and 5B illustrate tables included in metadata, in accordance with an embodiment of the present invention.

For example, the metadata may include an object table 510 and a replica location table 520. The object table 510 is illustrated in FIG. 5A and the replica location table 520 is illustrated in FIG. 5B. As shown in FIG. 5A, the object table 510 may include an object user ID, a directory ID, an object ID, and a content-specific index. As shown in FIG. 5B, the replica location table 520 may include information on locations of replicas by index.

The proxy server 250 may create the object table 510 as illustrated in FIG. 5A. For example, the proxy server 250 may apply a hash function on an ID of a respective object and a part of the content of a respective object. The proxy server 250 may store the hash result in an index column. The respective objects may be distinguished by the user ID, the directory ID, and the object ID. For example, the proxy server 250 may use a hash function MD5. In this case, the hash function MD5 may receive a message having an arbitrary length and generate a hash value having a fixed length of 128 bit. Accordingly, the index column may be set as 128-bits. An input value may be the first 64 megabytes in the contents of the object.

As shown in FIG. 5B, the replica location table 520 may include information on locations of replicas of an object. For example, the replica location table 520 of FIG. 5B shows three replica locations of each object. The present invention, however, is not limited thereto. In accordance with another embodiment of the present invention, the replica location table 520 may include information on more than three replicas. The replica location table 520 may include a content-specific index column and a plurality of location columns. Each index field of the content-specific index column may store a content-specific index of each object. Each index field may be mapped to at least one location field. Each location field may store a data node ID of a respective data node that may store a replica of a corresponding object.

For example, the object table 510 of FIG. 5A shows that an object “Ants” is stored in a directory “Movies” of a user “mjkim.” The object “Ants” may have a content-specific index of “24356” which may be calculated using the hash function MD5. Particularly, the hash function MD5 may be applied with the first 64 megabytes of the object “Ants”. The content-specific index of “24356” may be mapped to data node IDs of 24, 52, and 9 in the replica location table 520 of FIG. 5B. That is, the replica location table 520 of FIG. 5B shows that the object “Ants” of the user “mjkim” is stored in the data nodes 24, 52 and 9. In accordance with an embodiment of the present invention, the distributed storage system 200 may easily and effectively find replicas of a respective object using the object table 510 and the replica location table 520 included in the metadata.

In addition, each data node may use a content-specific index of a respective object as a key to store the respective object. In this manner, an object search process can be easily and efficiently performed. For example, each data node may create a folder based on a content specific index and store objects having the same content-specific index in the same folder. Accordingly, the deduplication operation may be performed more quickly.

FIG. 6 illustrates a distributed storage system having a deduplication function, in accordance with another embodiment of the present invention.

Referring to FIG. 6, a distributed storage system 600 in accordance with another embodiment of the present invention may include a plurality of clients 610, 611 and 612 and a plurality of data nodes 11 to 1n, 21 to 2n, and m1 to mn, which are coupled to a network 690. The distributed storage system 600 may further include an authentication server 620, a proxy server 650, a location-aware server 660, a replicator server 670, and a metadata database 680. The proxy server 650 may include a load balancer 655.

The clients 610, 611 and 612, the authentication server 620, and the metadata database 680 may have similar structures and perform similar functions as compared to those of the distributed storage system 200 of FIG. 2. Therefore, detailed descriptions thereof will be omitted herein. For example, when the proxy server 650 receives the object storage request, the proxy server 650 may apply a hash function to a target object and determine the hash result as a content-specific index of the target object. The proxy server 650 may use the content-specific index of the target object to determine whether the same object as the target object has already been stored in the data nodes.

Unlike the distributed storage system 200 of FIG. 2, the distributed storage system 600 may further include the location-aware server 660. The location-aware server 660 may select a zone group or a target data node. An authenticated client may inquire of the proxy server 650 about a data node to store a target object, which is a target data node. The proxy server 650 may request the location-aware server 660 to select the most suitable zone group.

In response to the request from the proxy server 650, the location-aware server 660 may select at least one zone group based on a basic replica policy of the client. The basic replica policy of the client may be the number of replicas of a respective target object that the client desires to have. For example, the location-aware server 660 may select a number of zone groups corresponding to the number of replicas of a target object that the client desires to store. The location-aware server 660 may transmit a list of the selected zone groups to the proxy server 650. The location-aware server 660 may consider various factors to select the most suitable zone groups. For example, the location-aware server 660 may refer to a physical location of the client to select the zone groups. The location-aware server 660 may determine the physical location of the client based on an IP address of the client, but the present invention is not limited thereto. Beside the physical location of the client, various other factors may be considered in selecting the zone group. The location-aware server 660 may determine priorities of the selected zone groups based on a distance between the client and a respective zone group. Based on the priorities of the selected zone groups, the client may select one target data node belonging to a zone group having the highest priority and store the target object in the selected target data node. Furthermore, the client may select at least one target data node belonging to zone groups having priorities lower than the highest priority and stores replicas of the target object in the selected target data nodes. FIG. 6 illustrates that the location aware server 600 may be a device independent from the proxy server 650. However, such a location-aware server 660 may be physically integrated with the proxy server 650.

In accordance with another embodiment of the present invention, a target data node belonging to the selected zone group may be determined by one of the proxy server 650 and the location-aware server 660. When the location-aware server 660 determines the target data node, the location-aware server 660 may select the target data node located in close proximity to the client having the target object within the zone groups based on the metadata database 680. Meanwhile, when the proxy server 650 selects the target data node, the proxy server 650 may use a load balancer 655 to check states of the data nodes belonging to the zone groups. The proxy server 650 may select the data node having the optimal condition as the target data node. In FIG. 6, the load balancer 655 is included in the proxy server 650, however, the present invention is not limited thereto. The load balancer 655 may be a device independent from the proxy server 650.

The proxy server 650 may manage information of the data nodes belonging to each zone group in the metadata. The proxy server 650 may previously determine priorities of the data nodes in consideration of storage capacities of the data nodes for load balancing. In response to the request from the client, a data node may be selected in consideration of the object storage history of the data nodes and the priorities of the data nodes. Accordingly, the load balancing among the data nodes within the zone group may be maintained.

As described above, the distributed storage system in accordance with an embodiment of the present invention may effectively support the deduplication function to efficiently provide the cloud storage service.

Furthermore, the distributed storage system may effectively support the replication function to provide the cloud storage service as well as the deduplication function.

Since the distributed storage system uses the content-specific index for determining the duplication of the target object, the distributed storage system can significantly reduce processing load and time.

Moreover, data nodes may be grouped by zone, and replicas may be distributed over different zones in accordance with an embodiment of the present invention. In this manner, even though one zone may malfunction due to errors on a related network, replicas stored in other zones may still be available. Accordingly, the distributed storage system may provide a cloud storage service with higher reliability.

The above-described embodiments of the present invention may also be realized as a program and stored in a computer-readable recording medium such as a CD-ROM, a RAM, a ROM, floppy disks, hard disks, magneto-optical disks, and the like. Since the process can be easily implemented by those skilled in the art to which the present invention pertains, further description will not be provided herein.

The term “coupled” has been used throughout to mean that elements may be either directly connected together or may be coupled through one or more intervening elements.

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A distributed storage system comprising:
a plurality of data nodes each configured to store at least one object; and
a server coupled with the plurality of data nodes through a network, the server configured to perform a deduplication function based on a content-specific index of a target object and content-specific indexes of objects stored in the plurality of data nodes in response to an object storage request from a client, and configured to store the target object in one of the plurality of data nodes based on a result of the deduplication function performed by the server.

2. The distributed storage system of claim 1, wherein the server calculates the content-specific indexes of the target object and the objects by applying a hash function on a portion of a content of each respective object.

3. The distributed storage system of claim 2, wherein:
the hash function is one of MD5, SHA1, SHA256, SHA384, SHA512, RMD128, RMD160, RMD256, RMD320, HAS160 and TIGER; and
the hash function receives the portion of the content of each respective object as an input and outputs a fixed length hash result as the content-specific index of the respective object.

4. A distributed storage system comprising:
an authentication server configured to authenticate a plurality of clients accessing the distributed storage system;
a plurality of data nodes each configured to store at least one object;
a metadata database configured to store metadata containing information on the at least one object of each of the plurality of data nodes and information on the plurality of data nodes each storing the at least one object; and
a proxy server configured to receive an object storage request from a first client of the plurality of clients to store a target object, determine a content-specific index based on contents of the target object, perform a deduplication function based on the determined content-specific index of the target object, select target data nodes from the plurality of data nodes based on a result of the performed deduplication function, and provide a list of the selected target data nodes to the first client,
wherein the first client stores the target object in at least one target node included in the list of the selected target data nodes.

5. The distributed storage system of claim 4, wherein the proxy server is configured to apply a hash function to a portion of the contents of the target object and determine a hash result of the applied hash function as the content-specific index of the target object.

6. The distributed storage system of claim 5, wherein:
the hash function is one of MD5, SHA1, SHA256, SHA384, SHA512, RMD128, RMD160, RMD256, RMD320, HAS160 and TIGER; and
the hash function receives the portion of the contents of the target object as an input and outputs a fixed length hash result.

7. The distributed storage system of claim 6, wherein the metadata comprises:
an object table comprising at least one of a user ID, a directory ID, an object ID, and the content-specific index; and
a replica location table comprising the content-specific index and at least one data node ID of a data node storing replicas of a respective object.

8. The distributed storage system of claim 7, wherein the metadata further comprises at least one of an available capacity of each data node of the plurality of data nodes, a list of data nodes belonging to each zone group, a priority of each zone group with respect to the target object, and a priority of each data node belonging to a first zone group.

9. The distributed storage system of claim 4, wherein:
the plurality of data nodes are grouped into at least one zone group; and
the proxy server is configured to select one target node from each zone group in order to store the target object into only one data node within each zone group.

10. The distributed storage system of claim 9, further comprising:
a location-aware server configured to select a plurality of zone groups within which to store the target object based on a location of the first client and determine priorities of the selected zone groups based on a distance between the first client and respective zone groups,
wherein the proxy server selects one target data node per selected zone group, updates the metadata database using a list of the selected target data nodes, and transmits the list of the selected target data nodes and the priorities of the selected zone groups to the first client, and
wherein the first client selects one target data node belonging to a zone group having a highest priority from among the selected zone groups, stores the target object within the selected one target data node, selects at least one target data nods belonging to zone groups having priorities lower than the highest priority, and stores replicas of the target object within the selected at least one target data node.

11. The distributed storage system of claim 10, wherein the proxy server assigns a priority to each data node belonging to one zone group based on an object storage history and a storage capacity of each data node, and determines a data node having the highest priority as the target data node.

12. The distributed storage system of claim 4, wherein:
the information on the at least one object comprises at least one of an ID, a size, a data type, and a creator of the at least one object; and
the information on the plurality of data nodes comprises at least one of an ID, an Internet protocol (IP) address, and a physical location of the plurality of data nodes.

13. A method for storing objects in a distributed storage system having a plurality of data nodes, the method comprising:
receiving an object storage request from a client intending to store a target object;
determining a content-specific index based on contents of the target object;
performing a deduplication function to determine whether or not the target object is duplicative of objects already stored within at least one of the plurality of data nodes based on the determined content-specific index; and
selecting at least one target data node from the plurality of data nodes within which to store the target object based on a result of the deduplication function, metadata including information on objects stored within the plurality of data nodes, and information on the plurality of data nodes storing the objects.

14. The method of claim 13, wherein the determining the content-specific index comprises applying a hash function on a portion of a content of the target object, wherein a hash result of the applied hash function is determined as the content-specific index of the target object.

15. The method of claim 14, wherein:
the hash function is one of MD5, SHA1, SHA256, SHA384, SHA512, RMD128, RMD160, RMD256, RMD320, HAS160, and TIGER; and
the hash function receives the portion of the content of each respective object as an input and outputs a fixed length hash result as the content-specific index of the respective object.

16. The method of claim 14, wherein:
the plurality of data nodes are grouped into at least one zone group; and
one target node is selected from each zone group in order to store the target object into only one data node within each zone group.

17. The method of claim 14, wherein the selecting the at least one target data node comprises:
selecting a plurality of zone groups within which to store the target object based on a location of the client and determining priorities of the selected zone groups based on a distance between the client and respective zone groups,
wherein one target data node is selected per selected zone group, the metadata database is updated using a list of the selected target data nodes, and the list of the selected target data nodes and the priorities of the selected zone groups are transmitted to the client, and
wherein the client selects one target data node belonging to a zone group having a highest priority from among the selected zone groups, stores the target object within the selected one target data node, selects at least one target data node belonging to zone groups having priorities lower than the highest priority, and stores replicas of the target object within the selected at least one target data node.

18. The method of claim 17, wherein a priority is assigned to each data node belonging to one zone group based on an object storage history and a storage capacity of each data node and a data node having the highest priority is selected as the target data node within the one zone group.

19. The method of claim 18, wherein the metadata further comprises at least one of an available capacity of each data node of the plurality of data nodes, a list of data nodes belonging to each zone group, a priority of each zone group with respect to the target object, and a priority of each data node belonging to the one zone group.

20. The method of claim 13, wherein the metadata comprises:
an object table comprising at least one of a user ID, a directory ID, an object ID, and the content-specific index; and
a replica location table comprising the content-specific index and an ID of a data node storing a replica of the object.
